(19) United States
(12) Patent Application Publication
(10) Pub. No.: US 2021/0211728 A1
(43) Pub. Date: Jul. 8, 2021

(54) Image Compression Method and Apparatus

(71) Applicant: Huawei Technologies Co., Ltd., Shenzhen (CN)

(72) Inventors: Kangwen Luo, Hangzhou (CN); Qunyu Ye, Hangzhou (CN); Jianmin Huang, Shenzhen (CN); Jianbo Xiang, Hangzhou (CN)

(21) Appl. No.: 17/206,742

(22) Filed: Mar. 19, 2021

Related U.S. Application Data
(63) Continuation of application No. PCT/CN2019/090773, filed on Jun. 11, 2019.

(30) Foreign Application Priority Data
Sep. 19, 2018 (CN) 201811096203.X
Dec. 28, 2018 (CN) 201811618308.7

(51) Int. Cl. H04N 19/625; H04N 19/176; H04N 19/18; H04N 19/159; H04N 19/124

(52) U.S. Cl. CPC H04N 19/625; H04N 19/176; H04N 19/124; H04N 19/159; H04N 19/18

(57) ABSTRACT

An image parallel compression method includes dividing data obtained after a discrete cosine transform (DCT) is performed on raw image data or data obtained after Huffman decoding is performed on image data of a joint photographic experts group (JPEG) format, or the like into several sub-blocks on a block basis, and then performing parallel operations such as intra-frame prediction, and arithmetic coding, to implement image parallel compression.

### CROSS-REFERENCE TO RELATED APPLICATION

This application is a continuation of International Patent Application No. PCT/CN2019/090773 filed on Jun. 11, 2019, which claims priority to Chinese Patent Application No. 201811096203.X filed on Sep. 19, 2018 and Chinese Patent Application No. 201811618308.7 filed on Dec. 28, 2018. All of the aforementioned patent applications are hereby incorporated by reference in their entireties.

### TECHNICAL FIELD

This application relates to the image processing field, and in particular, to an image compression method and apparatus.

### BACKGROUND

In both the conventional internet field and the mobile internet field, image processing always occupies a large bandwidth and more storage resources of a computing device. A large quantity of images are generated by a mobile phone, a website, and another digital facility, and are stored on a cloud or a local device. Therefore, during image transmission, the images are usually compressed first, to reduce an amount of data transmitted over a network. Currently, an image compression standard is a standard proposed by the Joint Photographic Experts Group (JPEG) in 1992, and is referred to as a JPEG standard. Tens of billions of images using the JPEG standard (JPEG images) are downloaded from the internet by users every day. However, a Huffman coding method is used for the JPEG images, without further optimization of redundancy of the images. As a result, a compression rate is not high, and lossless compression may be further performed on the images.

As a quantity and resolution of images increase, image traffic increases accordingly. This imposes an increasingly high requirement on a delay and a compression rate of image compression. Therefore, an image of a JPEG format, or the like needs to be compressed. A lack of an appropriate parallel compression architecture in an existing image compression method results in defects such as occupation of excessive memory resources and a low compression rate.

### SUMMARY

Embodiments of this application provide an image compression method and apparatus, to resolve defects of excessively high memory resource occupation and a low compression rate that occur in an existing image compression solution.

According to a first aspect, this application provides an image compression method. The method is applied to a computer apparatus. The method includes obtaining N blocks in first image data, where the first image data is intermediate data obtained after a discrete cosine transform (DCT) is performed on raw image data, a size of each of the N blocks is equal to a size of a coding unit, the coding unit is a data unit used in a process of performing the DCT on the raw image data, and N is a positive integer, dividing each of the N blocks into M sub-blocks, to obtain N×M sub-blocks, where M is a positive integer, and separately compressing each of the N×M sub-blocks, and encapsulating compressed data, to obtain second image data.

In the foregoing practice, each block in the first image data is divided into several sub-blocks, and then each sub-block is separately compressed. In this way, the first image data may be compressed in parallel sub-block by sub-block, to improve image compression efficiency.

In a possible implementation of the first aspect of this application, the dividing each of the N blocks into M sub-blocks includes dividing each block into M sub-blocks by using a same division method, where the i^{th} sub-block in each block after division is associated with each other, locations or coordinates of the i^{th} sub-blocks in any two blocks are the same, and 1≤I≤M.

In this way, each block is divided into M sub-blocks by using the same method, to facilitate subsequent compression of data of the M sub-blocks, and improve the image compression efficiency.

In another possible implementation of the first aspect of this application, the dividing each of the N blocks into M sub-blocks includes dividing each of the N blocks into M sub-blocks based on energy distribution of each of the N blocks, where the energy distribution reflects distribution of values of data included in each block.

In this way, each of the N blocks in the first image data is divided into M sub-blocks based on the energy distribution, so that the values of data included in each sub-block are comparatively close. In this case, when intra-frame prediction and arithmetic coding are subsequently performed on the data included in the sub-block, a calculation volume is reduced, and the image compression efficiency is improved.

In another possible implementation of the first aspect of this application, the separately compressing data included in each of the N×M sub-blocks includes performing intra-frame prediction on data included in each of the N×M sub-blocks, to obtain first intermediate data corresponding to each sub-block, and separately performing arithmetic coding on the first intermediate data corresponding to each of the N×M sub-blocks, to obtain compressed data corresponding to each of the N×M sub-blocks.

In the foregoing practice, a step of compressing the first image data is refined. In other words, compressing the first image data specifically includes the intra-frame prediction and the arithmetic coding. The intra-frame prediction and the arithmetic coding are performed on the first image data, so that redundancy of the image data can be optimized, and compression of the first image data can be implemented.

In another possible implementation of the first aspect of this application, the separately performing arithmetic coding on the first intermediate data corresponding to each of the N×M sub-blocks, to obtain compressed data corresponding to each of the N×M sub-blocks includes obtaining M probability models, and separately performing arithmetic coding on a first block by using the M probability models, to obtain compressed data corresponding to the first block, where each sub-block corresponds to one probability model, and the first block is one of the N blocks, and performing arithmetic coding on a next block by using the M probability models, to obtain compressed data corresponding to the next block, where the next block and a sub-block associated with a previous block use a same probability model.

In the foregoing practice, after the arithmetic coding is completed on the data corresponding to the first sub-block, the used probability model is used to perform arithmetic coding on data corresponding to a second sub-block. In this way, when the computer apparatus performs the image parallel compression, a size of a probability model that needs to be stored at a same time is equivalent to a size of a probability model corresponding to a block, to reduce a size of storage space that needs to be reserved.

In another possible implementation of the first aspect of this application, the encapsulating compressed data includes encapsulating compressed data of a plurality of sub-blocks to obtain the second image data, where the second image data includes a header field part and a data part, the header field part is used to indicate a data volume of compressed data corresponding to each sub-block, and the data part is used to carry the compressed data corresponding to each sub-block.

In the foregoing practice, a step of encapsulating the compressed data is refined. In other words, the encapsulated second image data includes the header field part and the data part. In this way, in the data part of the second image data, no interval is required between the compressed data corresponding to each sub-block, to further improve an image compression rate. If the second image data needs to be decompressed subsequently to restore the first image data, the size of the data volume of the compressed data corresponding to each sub-block may be determined based on the header field part of the second image data, to determine and further process the compressed data corresponding to each sub-block.

In another possible implementation of the first aspect of this application, the obtaining N blocks in first image data includes receiving the raw image data, and performing a DCT on the raw image data, or receiving JPEG image data, and performing Huffman decoding on the JPEG image data.

Because the JPEG image data is obtained by performing a DCT and Huffman coding on the raw image data, the first image data in this application is data obtained after the DCT is performed on the raw image data. Therefore, the N blocks in the first image data may be obtained by performing a DCT on the raw image data, or may be obtained by performing Huffman decoding on the JPEG data. In this way, the technical solutions provided in this application can be used to process both raw image data and the JPEG image data. Therefore, an application scope of the technical solutions provided in this application is increased.

In another possible implementation of the first aspect of this application, the N blocks include a first block and a second block, first intermediate data corresponding to a i^{th} sub-block in the second block is obtained by performing intra-frame prediction on first intermediate data corresponding to a k^{th} sub-block in the first block, 1≤j≤M, and 1≤k≤M.

In the foregoing practice, the intra-frame prediction may be performed based on data in another block during the intra-frame prediction, to improve the image compression rate.

According to a second aspect, this application provides a computer apparatus. The computer apparatus is configured to compress an image. The apparatus includes a receiving module, configured to obtain N blocks in first image data, where the first image data is intermediate data obtained after a DCT is performed on raw image data, a size of each of the N blocks is equal to a size of a coding unit, the coding unit is a data unit used in a process of performing the DCT on the raw image data, and N is a positive integer, a division module, configured to divide each of the N blocks into M sub-blocks, to obtain N×M sub-blocks, where M is a positive integer, and a compression module, configured to separately compress each of the N×M sub-blocks, and encapsulate compressed data, to obtain second image data.

In a possible implementation of the second aspect of this application, when dividing each of the N blocks into M sub-blocks, the division module is specifically configured to divide each block into M sub-blocks by using a same division method, where the i^{th} sub-block in each block after division is associated with each other, locations or coordinates of the i^{th} sub-blocks in any two blocks are the same, and 1≤i≤M.

In another possible implementation of the second aspect of this application, when dividing each of the N blocks into M sub-blocks, the division module is specifically configured to divide each of the N blocks into M sub-blocks based on energy distribution of each of the N blocks, where the energy distribution reflects distribution of values of data included in each block.

In another possible implementation of the second aspect of this application, when separately compressing each of the N×M sub-blocks, the compression module is specifically configured to perform intra-frame prediction on data included in each of the N×M sub-blocks, to obtain first intermediate data corresponding to each sub-block, and separately perform arithmetic coding on the first intermediate data corresponding to each of the N×M sub-blocks, to obtain compressed data corresponding to each of the N×M sub-blocks.

In another possible implementation of the second aspect of this application, when separately performing arithmetic coding on the first intermediate data corresponding to each of the N×M sub-blocks, the compression module is specifically configured to obtain M probability models, and separately perform arithmetic coding on a first block by using the M probability models, to obtain compressed data corresponding to the first block, where each sub-block corresponds to one probability model, and the first block is one of the N blocks, and perform arithmetic coding on a next block by using the M probability models, to obtain compressed data corresponding to the next block, where the next block and a sub-block associated with a previous block use a same probability model.

In another possible implementation of the second aspect of this application, when encapsulating the compressed data, the compression module is specifically configured to encapsulate compressed data of a plurality of sub-blocks to obtain the second image data, where the second image data includes a header field part and a data part, the header field part is used to indicate a data volume of compressed data corresponding to each sub-block, and the data part is used to carry the compressed data corresponding to each sub-block.

In another possible implementation of the second aspect of this application, when obtaining the N blocks in the first image data, the receiving module is specifically configured to receive the raw image data, and perform a DCT on the raw image data, or receive JPEG image data, and perform Huffman decoding on the JPEG image data.

In another possible implementation of the second aspect of this application, the N blocks include a first block and a second block, first intermediate data corresponding to a j^{th} sub-block in the second block is obtained by performing intra-frame prediction on first intermediate data corresponding to a k^{th} sub-block in the first block, 1≤j≤M, and 1≤k≤M.

According to a third aspect, this application provides a computer apparatus. The computer apparatus includes a processor and a memory. The memory stores program code. The processor is configured to invoke the program code in the memory to perform the image compression method according to the first aspect.

According to a fourth aspect, this application provides a non-transitory computer-readable storage medium. The computer-readable storage medium stores a computer program. When the computer program is executed by a computing device, the image compression method according to the first aspect is implemented.

According to a fifth aspect, this application provides a computer program product. When the computer program product runs on a processor, the image compression method according to the first aspect may be implemented.

### BRIEF DESCRIPTION OF DRAWINGS

FIG. 1 is a schematic flowchart of a technical solution of parallel compression on JPEG image data in other approaches.

FIG. 2 is a schematic diagram of direct coefficient (DC)/alternating coefficient (AC) coefficients that are obtained through a DCT in other approaches.

FIG. 3 is a schematic diagram of a hardware architecture according to an embodiment of this application.

FIG. 4 is a schematic diagram of another hardware architecture according to an embodiment of this application.

FIG. 5 is a schematic flowchart of an embodiment of this application.

FIG. 6 is a schematic diagram of converting raw image data block on a block basis into DC/AC coefficients according to an embodiment of this application.

FIG. 7 is a schematic diagram of a distribution rule of values of DC/AC coefficients in a block according to an embodiment of this application.

FIG. 8 is a schematic diagram of a method for dividing a block into sub-blocks according to an embodiment of this application.

FIG. 9 is a schematic diagram of a method for dividing a block into sub-blocks according to an embodiment of this application.

FIG. 10 is a schematic diagram of another method for dividing a block into sub-blocks according to an embodiment of this application.

FIG. 11 is a schematic diagram of an encapsulation format of second image data according to an embodiment of this application.

FIG. 12 is a schematic diagram of another encapsulation format of second image data according to an embodiment of this application.

FIG. 13 is a schematic flowchart of another embodiment of this application.

FIG. 14 is a schematic diagram of modules of a computer apparatus according to an embodiment of this application.

FIG. 15 is a schematic diagram of a structure of a computer apparatus according to an embodiment of this application.

### DESCRIPTION OF EMBODIMENTS

The following explains various embodiments of this application in further detail.

Huffman coding indicates an entropy coding algorithm used for lossless data compression in computer data processing. Specifically, a variable-length code table is used in the Huffman coding to encode a signal source symbol (for example, a letter in a file). The variable-length code table is obtained by using a method for evaluating an occurrence probability of a source symbol. A letter with a high occurrence probability uses short coding. On the contrary, a letter with a low occurrence probability uses long coding. This reduces an average length of a character string after the coding and an expected value, to achieve a purpose of the lossless data compression.

For example, when a text including 1000 characters needs to be encoded and the text includes six characters such as a, b, c, d, e, and f, occurrence frequencies of the characters are different, as shown in the following table.

TABLE 1
Huffman code table

| | a | b | c | d | e | f |
|---|---|---|---|---|---|---|
| Frequency (100 | 45 | 13 | 12 | 16 | 9 | 5 |
| times) | | | | | | |
| Fixed-length code | 000 | 001 | 010 | 011 | 100 | 101 |
| Variable-length code | 0 | 101 | 100 | 111 | 1101 | 1100 |

If the text is encoded by using a fixed length, assuming that each character is represented by using 3 bits, a total of 3000 bits of storage space is required for a coding result. If the text is encoded by using a variable length, (45×1+13×3+12×3+16×3+9×4+5×4)×10=2240 bits are required for a coding result, and a size of required storage space is reduced by about 25%. At the same time, a Huffman decoder can recover a raw code stream losslessly by using a same code table. In a Huffman coding process when JPEG image data is generated, the Huffman table is stored in a JPEG header field part. During decoding, the JPEG header field part is parsed to obtain the Huffman table for decoding.

The Huffman coding for the signal source symbols usually includes the following steps. Step 1. Arrange probabilities of the signal source symbols in descending order Step 2. Add two minimum probabilities, repeat this step, and always place a higher probability branch on the right, until a sum of finally added probabilities is 1. Step 3. Specify a left one of each pair of combinations as 0 and a right one as 1 (or the opposite) Step 4. Draw a path from a probability 1 to each signal source symbol, and sequentially record 0 and 1 along the path, to obtain a Huffman code word corresponding to the symbol.

Intra-frame prediction indicates generating a predictor based on a value of a selected pixel, and is used to predict a value of an adjacent pixel in a same frame of image, to reduce a quantity of bits required to represent the value of the adjacent pixel. The intra-frame prediction may be used because colors of the same frame of image are usually smoothly transited, so that values of several pixels close to each other in the same frame of image are correlated. Therefore, a pixel value of a pixel may be predicted based on a value of an adjacent pixel in the same frame of image, to achieve an objective of reducing image data redundancy effectively and improving an image compression rate. The intra-frame prediction usually includes the following steps. Step 1. Use the adjacent pixel for the pixel in the same frame of image as a reference to calculate the predictor P of the pixel. Step 2. Use a difference D between an original value X and the predictor P of the pixel to represent the pixel. During data restoration, the original value X may be restored by adding the difference D to the predictor P.

Arithmetic coding indicates an entropy coding algorithm used for lossless data compression in computer data processing, and may directly encode input data into a decimal greater than or equal to 0 and less than 1. Specifically, an original interval is first selected, and the original interval is usually [0, 1). When the arithmetic coding is performed, the original interval is divided into several segments based on an occurrence probability of each element of to-be-encoded data. Each element corresponds to a specific interval. Each time after one element is encoded, an original interval is narrowed down to a new interval based on a type of the element. An interval is sequentially adjusted based on a type of an element of the to-be-encoded data, until all the elements of the to-be-encoded data are encoded. In this case, any number in a current interval can be output as a coding result.

For example, assuming that the to-be-encoded data includes three elements A, B, and C, a probability of A is 30%, a probability of B is 20%, and a probability of C is 50%, it may be considered that A corresponds to 0-30%, B corresponds to 30%-50%, and C corresponds to 50%-100%. When “ABC” is encoded, the initial interval [0, 1) is first narrowed down to [0, 0.3) based on the range 0-30% corresponding to A. 30% to 50% of the current range [0, 0.3) is [0.09, 0.15) based on the range 30%-50% corresponding to B. Then, the current interval is further narrowed down to [0.120, 0.150) based on the range 50%-100% corresponding to C. In this case, a coding result of “ABC” is any number selected from the current interval, for example, 0.130. In the image processing field, the arithmetic coding is usually performed on binary data. Therefore, each bit of the to-be-encoded data has only two cases 0 and 1. A coding principle is the same as that of the arithmetic coding described above.

A coding unit in this application indicates a unit for performing a DCT on raw image data and a unit for performing Huffman decoding on image data of a JPEG format. Specifically, the raw image data includes data corresponding to each pixel. When the DCT is performed, the DCT is performed on data corresponding to pixels of eight rows and eight columns or pixels of 16 rows and 16 columns. The pixels of the eight rows and the eight columns or the pixels of the 16 rows and the 16 columns are referred to as the coding unit. The image data of the JPEG format, and the like is obtained by performing DCT coding and Huffman coding on the raw image data. Therefore, when the Huffman decoding is performed, the Huffman decoding is also performed on the data corresponding to the pixels of the eight rows and the eight columns or the pixels of the 16 rows and the 16 columns on which the DCT is originally performed. Therefore, the coding unit in this application is the unit for performing DCT on the raw image data and the unit for performing Huffman decoding on the image data of the JPEG format.

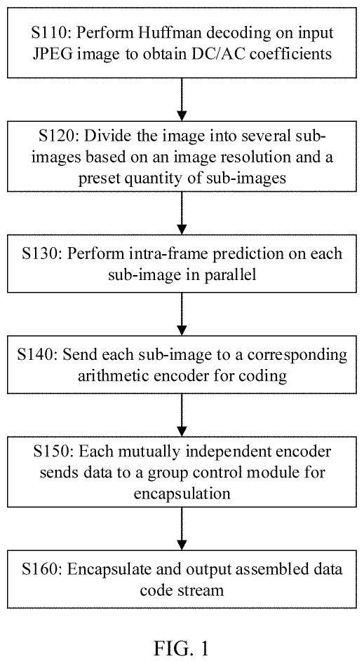

FIG. 1 is a schematic flowchart of a technical solution of parallel compression on JPEG image data in other approaches.

S110. Perform Huffman decoding on input JPEG image data to obtain DC/AC coefficients.

The JPEG image data is obtained by compressing raw image data. In the compression, DCT and Huffman coding are performed on a raw image. The raw image data indicates image data that is not processed, and is usually obtained by sequentially representing a value of each pixel in the image by using a red-blue-green (RGB) component.

The DCT is used to transform the raw image data from time domain to frequency domain, to obtain the DC/AC coefficients. With reference to a formula of the DCT,

$$F ( u , v ) = c ( u ) c ( v ) + {\sum }_{i = 0}^{N - 1} {\sum }_{j = 0}^{N - 1} f ( i , j ) cos [ \frac{( i + 0.5 ) π}{N} u ] cos [ \frac{( j + 0.5 ) π}{N} v ]$$

$$c ( u ) = \{ \begin{matrix}\sqrt{\frac{1}{N}} , & u = 0 \\ \sqrt{\frac{2}{N}} , & u \neq 0\end{matrix}$$

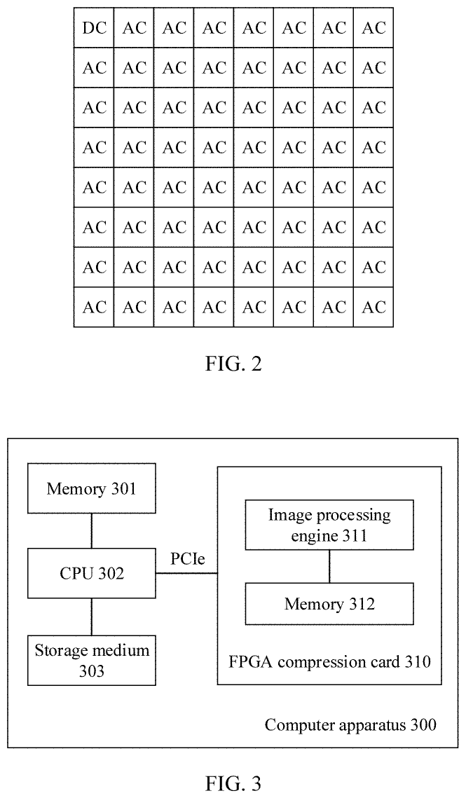

When both u and v are equal to 0, an obtained DCT result is the direct coefficient, and a remaining DCT result is the alternate coefficient, where u and v respectively indicate a horizontal coordinate and a vertical coordinate of the raw image data, and both are counted starting from 0. When the DCT is performed on the raw image, the DCT is usually performed on data in eight rows and eight columns or 16 rows and 16 columns. A data size on which the DCT is performed at a time is a coding unit. FIG. 2 is a schematic diagram of DC/AC coefficients obtained through DCT in other approaches. As shown in FIG. 2, a coding unit with eight rows and eight columns includes 64 coefficients in total. In coefficients obtained through the DCT shown in FIG. 2, only coordinates (0, 0), namely, a coefficient in a first row and a first column in the coding unit is the direct coefficient, and remaining 63 coefficients are the alternate coefficients.

After the to-be-compressed JPEG image data is received, the JPEG image data is parsed to obtain information such as image size information and a Huffman table of the DC/AC coefficients. The Huffman decoding is performed on the JPEG image data based on the information, to obtain the DC/AC coefficients after the DCT. The DC/AC coefficients of the image are stored in a reserved buffer.

S120. Divide the image into several sub-images based on an image resolution and a preset quantity of sub-images.

When the entire frame of image is divided into the several sub-images, because the data obtained after the decoding is not necessarily arranged according to a sequence of a pixel corresponding to the data in the image, the data of the entire frame of image usually needs to be buffered first. Then, the sub-image is divided. This requires that the reserved buffer can store the entire frame of image. In addition, the Huffman decoding needs to be first completed on the entire frame of the JPEG image before subsequent parallel coding is performed, which increases an image compression delay.

S130. Perform intra-frame prediction on each sub-image in parallel.

The intra-frame prediction is performed on each sub-image, and a difference between an actual value and a predictor of each element in a sub-image is used to replace the raw DC/AC coefficients. Therefore, a to-be-stored data volume is reduced, and a calculation volume of subsequent arithmetic coding is reduced.

If an element A in one sub-image is obtained by performing intra-frame prediction on an element B in another sub-image, when a value of the element A is restored, all data in the sub-image in which the element B is located needs to be restored first, and then the value of the element A can be restored. In this way, efficiency is greatly reduced. Therefore, the intra-frame prediction is performed only on elements in each sub-image without performing intra-frame prediction on an element in another sub-image. In this way, some gains brought by eliminating redundancy through the intra-frame prediction are lost, and an image compression rate is reduced.

S140. Send a result after the intra-frame prediction is performed on each sub-image to a corresponding arithmetic encoder for the arithmetic coding.

After the intra-frame prediction is completed on each sub-image, binarization processing is performed on the result after the intra-frame prediction is performed on each sub-image, and then the result is sent to the corresponding arithmetic encoder for the coding. The binarization processing indicates converting the result after the prediction is performed on each sub-image into a binary code stream with a value of 0 or 1. When the arithmetic coding is performed on the data included in the sub-image, a probability model needs to be used. The probability model is used to predict occurrence probabilities of various elements in a next to-be-encoded bit, and usually includes three variables. A count 0 variable is used to record a quantity of occurrence times of 0s in an encoded bit stream, a count 1 variable is used to record a quantity of occurrence times of 1s in the encoded bit stream, and a PROB variable is used to represent a probability that a current to-be-encoded bit is 0.

Because sub-images are independent of each other, corresponding arithmetic coding is also independent of each other. Based on the independent probability model, the arithmetic coding is performed on image data after the binary processing is performed. In this case, when the to-be-compressed image is divided into N sub-images, N probability models need to be stored.

The data that needs to be encoded in each sub-image includes DC/AC coefficients, bit width information, symbol information, predictor information, and the like. Each type of information needs to provide a corresponding probability in the probability model. Therefore, the probability model corresponding to one frame of JPEG image usually requires comparatively large storage space, so that the probability model can include all cases that may occur in the coding. For example, a probability model in a lossless image compression technology “Lepton” released by DROPBOX in 2016 has 721564 probability tables in total. Each probability table requires 24-bit storage space. In other words, each of the three variables in each probability table is identified by using 8 bits. Therefore, each probability model requires at least 2-megabyte (MB) storage space. In other words, when the to-be-compressed image is divided into the N sub-images, about 2×N-MB memory space needs to be provided for the parallel coding on the N sub-images, to store the probability model.

S150. Combine and encapsulate coding results obtained by encoders that are independent of each other, to obtain compressed image data.

S160. Output the compressed image data.

The solution for performing parallel compression on the JPEG image is dividing the complete frame of image into the several sub-images that are independent of each other, and then separately performing intra-frame prediction and the arithmetic coding. However, in the practice, all the entire frame of image needs to be buffered and a plurality of probability models need to be stored. Consequently, a comparatively large memory resource is consumed. In addition, a key of generating a compression gain for the JPEG image through the compression is eliminating the data redundancy in the image through the intra-frame prediction. However, currently, the image is divided into the several sub-images, and the data of each sub-image is independent of each other, and cannot be used as a whole to perform intra-frame prediction. Therefore, the gain brought by eliminating the data redundancy in the image through the intra-frame prediction and the image compression rate are reduced.

To resolve problems of high memory resource consumption and a low compression rate that occur when the JPEG image is compressed in parallel in other approaches, this application provides a new parallel compression method. Data obtained after Huffman decoding is performed on JPEG image data is directly output based on a block of a size of a coding unit, without requiring buffering an entire frame of image. Further, each block may be further divided into several sub-blocks (also referred to as slices). Intra-frame prediction and arithmetic coding are performed in parallel on a sub-block included in each block. Because each block is the size of the coding unit, the intra-frame prediction may be performed between the blocks and between the sub-blocks. Therefore, there is no great impact on restoration efficiency. In addition, during the arithmetic coding, an arithmetic model for the sub-block included in each block may reuse an arithmetic model for a corresponding sub-block in a previous encoded block. Therefore, a size of a probability model that needs to be stored is reduced, and memory resource consumption is saved.

FIG. 3 is a schematic diagram of a hardware architecture according to an embodiment of this application. As shown in FIG. 3, this application may be executed by a computer apparatus 300. The computer apparatus 300 includes a memory 301, a central processing unit (CPU) 302, and a storage medium 303. The CPU is connected to a field-programmable gate array (FPGA) compression card 310 by using a bus. The bus may use a Peripheral Component Interconnect Express (PCIe) standard. PCIe is a high-speed serial point-to-point dual-channel high-bandwidth transmission technology that implements end-to-end reliable transmission between the CPU 302 and the FPGA compression card 310. The FPGA compression card 310 is connected to a server in a form of an add-in card. The FPGA compression card 310 includes an image processing engine 311, a memory 312, and electronic components that should be included in some other compression cards. The image processing engine 311 is a related program of an image compression solution provided in this application, and may perform Huffman decoding on a JPEG image, perform an intra-frame prediction operation and an arithmetic coding operation to complete image data compression, and write a file obtained after the image data compression into Memory 301.

During the image data compression, the CPU 302 stores to-be-compressed image data in the memory 301, and sends the to-be-compressed image data to the FPGA compression card 310. The FPGA compression card 310 reads the image from the memory 301, sends the image to the image processing engine 311, and buffers intermediate data generated in an image compression process to the memory 312. After an entire frame of image is compressed, the image is read from the memory 312, encapsulated, and sent to the memory 301 through a PCIe interface, to complete the image compression. The FPGA compression card 310 may read the image from the memory 301 in a PCIe direct memory access (DMA) manner. In this manner, the data may be directly read from the memory 301 by using a DMA controller, to reduce resource usage of the CPU 302.

It should be noted that, in addition to an FPGA, the compression card in this application may also be a graphic processing unit (GPU) or a digital signal processing (DSP) chip. This is not limited in this application. The computer apparatus 300 may alternatively not include the FPGA compression card 310. The image processing engine 311 may be stored in the memory 301 or the storage medium 303 as a program. When an image needs to be compressed, the CPU 302 calls the image processing engine 311 in the memory 301 or the storage medium 303 to complete a corresponding operation. An existence form of the image processing engine 311 is not limited in this application.

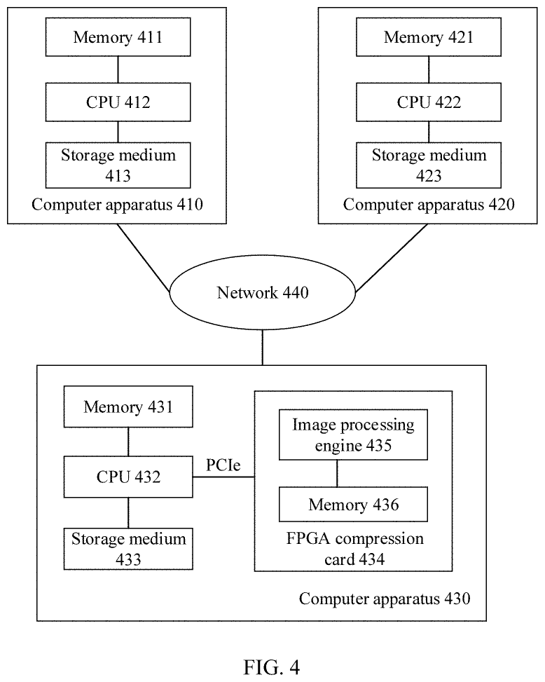

FIG. 4 is a schematic diagram of another hardware architecture according to an embodiment of this application.

As shown in FIG. 4, the technical solutions provided in this application may be performed by a computer cluster 400. The computer cluster 400 includes at least two computer apparatuses (three computer apparatuses shown in the figure), and a computer apparatus 430 is used in this application. The computer apparatus 430 includes an FPGA compression card 434, configured to specially provide an image compression and decompression service for the entire computer cluster 400. When a computer apparatus, for example, a computer apparatus 410, in the computer cluster 400 needs to compress an image, the image is sent to the computer apparatus 430 by using a network 440. The network 440 that connects the computer apparatus 410 and the computer apparatus 430 may be a wired network such as a network cable or an optical fiber, or may be a wireless network such as a wireless local area network (WLAN) or a BLUETOOTH (BT). This is not limited in this application. The technical solution provided in this application is performed by the computer cluster 400 shown in FIG. 4. Some computer apparatuses that are in the computer cluster 400 that are suitable for image processing are specially used for performing an image compression operation. This helps better configure a computing resource.

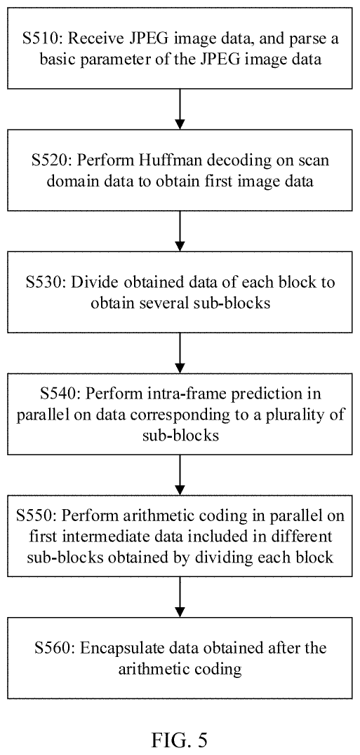

FIG. 5 is a schematic flowchart of an embodiment of this application.

S510. Receive JPEG image data, and parse a basic parameter of the JPEG image data.

The JPEG image data is parsed to obtain data including the following two parts. One part is data obtained after DCT and Huffman coding are performed on raw image data, which is called a scan domain, and the other part is JPEG header field data including a quantization table used to quantize DC/AC coefficients after the DCT, image width and height information, a Huffman table corresponding to the DC/AC coefficients, and the like.

S520. Perform Huffman decoding on scan domain data to obtain first image data.

A Huffman tree is first reconstructed based on the Huffman table corresponding to the DC/AC coefficients obtained by parsing the image, and then the Huffman decoding is performed on the scan domain data, to obtain data represented by using a digital luma-chroma-chroma (YCbCr) scheme.

The YCbCr scheme is a scheme of a color model given in a development process of a world digital organization video standard. The color model is a model used to describe a color in a generally acceptable manner under a specific standard. The color models include schemes such as, RGB, analog luma-chroma-chroma (YUV), and YCbCr. An RGB scheme comprising RGB elements which represent red, green, and blue, is space defined based on colors recognized by human eyes and may represent most colors. In the RGB scheme, digital adjustment is difficult to be performed on details, and hue, luminance, and saturation are represented together. Therefore, the RGB scheme has a specific limitation. Currently, the RGB scheme is mainly used as a hardware-oriented color model scheme. Based on the RGB scheme, a YUV scheme is used to generate a black-and-white image from a full-color image, convert extracted three main colors into two additional signals for description, and then combines the three signals to restore the full-color image. A YCbCr scheme is generated after scaling and offset are performed on the YUV scheme. Y is used to indicate a luminance component in an image, and Cr and Cb are used to respectively indicate red chrominance component and blue chrominance component in the image. The RGB scheme, the YUV scheme, and the YCbCr scheme may be mutually converted according to a formula. Therefore, data represented by using the RGB scheme or the YUV scheme may also be obtained in this application. This is not limited in this application. For ease of description, the YCbCr scheme is used for description in this application.

After the first image data represented by using the YCbCr scheme is obtained, subsequent processing is performed on the first image data on a block basis. A size of a block is the same as a size of a coding unit. In other words, a size of a unit for performing DCT on the raw image data is usually eight rows and eight columns, or may be of another size, for example, four rows and four columns or 16 rows and 16 columns. This is not limited in this embodiment of this application. Because the DCT is performed on the raw image in coding units, data on the block basis may be directly obtained after the Huffman decoding is performed on the scan domain data of the JPEG image in the step S520.

Optionally, in a process of converting the raw image data into the JPEG image data, the image data may be quantized, namely, scaled up according to a specific proportion. If a quantization step exists in the conversion process, in the step S520, the obtained data may be dequantized based on the information such as the quantization table in the JPEG header field data.

Optionally, this embodiment may also be used to process image data of a format similar to that of the JPEG image, for example, image data of a WebP format. The image data needs to be obtained after the DCT and another operation are performed on the raw image data. Therefore, as long as some reverse operations are correspondingly performed, the data obtained after the DCT is performed on the raw image may be obtained, and is used for the following steps in this embodiment.

S530. Divide obtained data of each block to obtain several sub-blocks.

Data included in a block is the data obtained after the DCT is performed on the raw image data. When the raw image data is converted into the JPEG image data, because of a strong correlation between adjacent pixels, energy of the raw image data is usually evenly distributed in time domain. Therefore, the raw image data needs to be re-processed after the DCT.

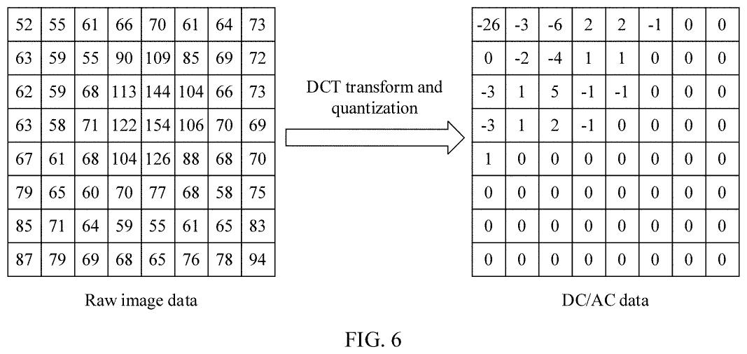

FIG. 6 is a schematic diagram of converting the raw image data on a block basis into the DC/AC coefficients according to this embodiment of this application. It can be seen from the figure that, most of elements in a lower right corner of a converted DC/AC coefficient matrix are 0, and absolute values of elements in an upper left corner of the matrix are comparatively large. In other words, after the DCT conversion is performed on the raw image data, most energy is concentrated in the upper left corner of the block.

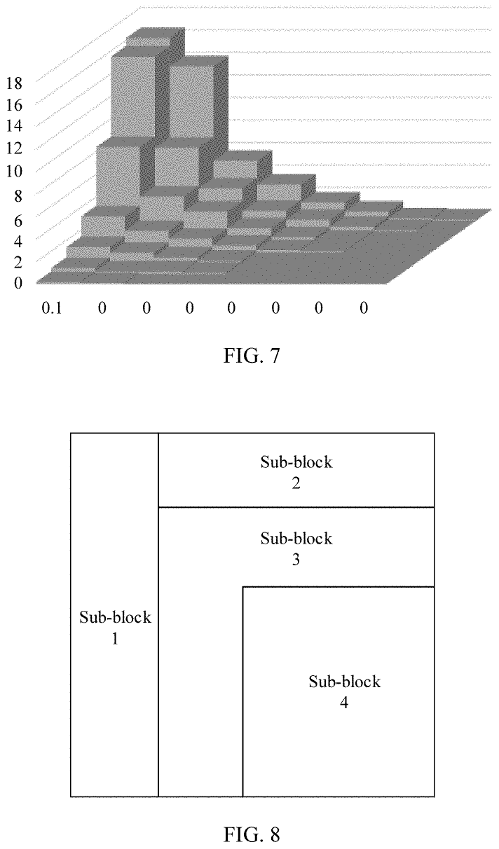

FIG. 7 is a schematic diagram of a distribution rule of values of DC/AC coefficients in the block according to this embodiment of this application. To reflect the features more clearly, FIG. 7 is the schematic diagram obtained by analyzing and collecting statistics of distribution of the values of the DC/AC coefficients in the block in a large amount of JPEG image data. A horizontal plane in FIG. 7 indicates the block including the DC/AC coefficients. A vertical plane indicates values of the DC/AC coefficients at a location of the block, namely, an energy magnitude corresponding to the location. It can be seen from FIG. 7 that, energy corresponding to the DC/AC coefficients is the highest at an upper left corner of the block, energy gradually decreases moving downward to a right direction, and energy corresponding to a lower right corner of the block is 0.

Based on the distribution rule of the values of the DC/AC coefficients in the block, FIG. 8 shows a method for dividing the block into the sub-blocks according to this embodiment of this application. As shown in FIG. 8, in this example, the block is divided into four parts according to an energy distribution rule in the block. A first sub-block is located at a leftmost side of the block. A second sub-block is located at an uppermost side of the block and does not overlap the first sub-block. A fourth sub-block is located in a lower right corner of the block. A remaining part of the block is a third sub-block.

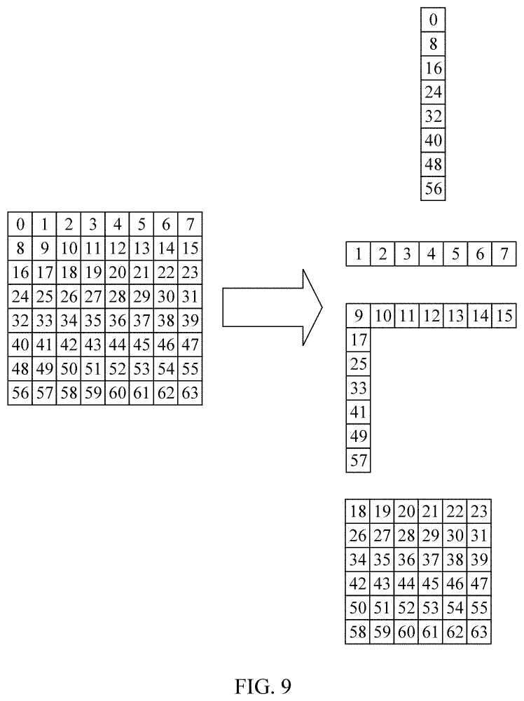

FIG. 9 further shows a method for dividing the block into the sub-blocks. As shown in FIG. 9, the size of the block is eight rows and eight columns. 64 elements included in each block are sequentially numbered 0 to 63 from top to bottom and from left to right (the elements in the block may also be numbered based on horizontal and vertical coordinates). A first sub-block obtained through division is at a leftmost side of the block. A second sub-block obtained through division is at a topmost side of the block and does not overlap the first sub-block. A fourth sub-block is located in a lower right corner of the block. A remaining part is a third sub-block. Each block is divided into the sub-blocks by using a same division method in this application. The i^{th} sub-block in each block after the division is associated with each other. Locations or coordinates of the i^{th} sub-blocks in any two blocks are the same, and 1≤I≤M. For example, when a first sub-block obtained by dividing a block is located at a leftmost side of the block, and when elements numbered 0, 8, 16, 24, 32, 40, 48, and 56 are included, a first sub-block obtained by dividing another block also need to be located on the leftmost side of the block, elements numbered 0, 8, 16, 24, 32, 40, 48, and 56 are included.

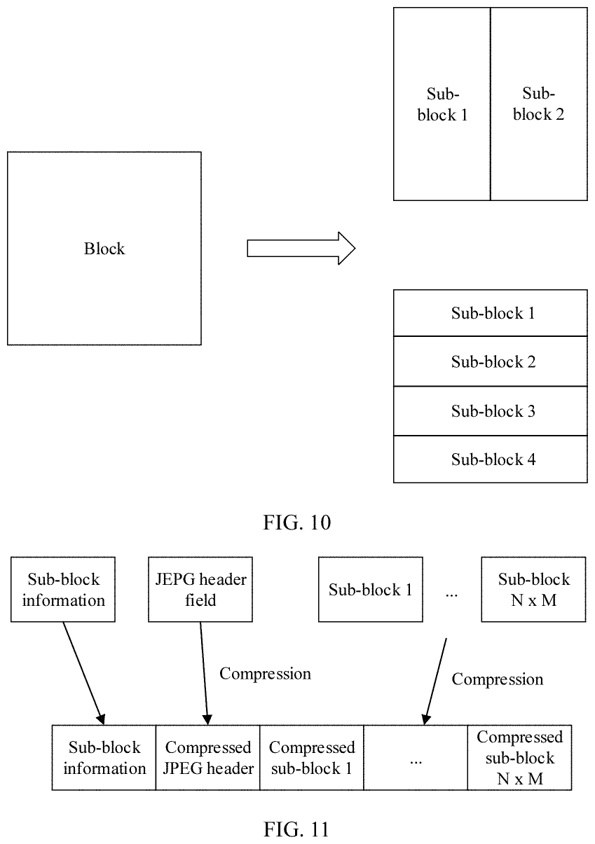

It should be noted that in this embodiment of this application, there may be a plurality of block division manners, and a quantity of sub-blocks obtained through the division and a division manner are not limited. FIG. 10 is a schematic diagram of another method for dividing the block into the sub-blocks according to this embodiment of this application. As shown in FIG. 10, the block of an L×L size may be vertically divided to obtain two sub-blocks whose width is L. Alternatively, the block of an L×L size may be horizontally divided, to obtain four sub-blocks whose lengths are L.

S540. Perform intra-frame prediction in parallel on data corresponding to a plurality of sub-blocks.

An image processing engine provided in this embodiment of this application may perform intra-frame prediction on the first image data in the plurality of sub-blocks in parallel, to obtain a predictor and a difference that correspond to a pixel in each sub-block. For the intra-frame prediction, an adjacent pixel in a same frame of image is used as a reference to calculate a predictor P of a to-be-encoded pixel, and then subsequent arithmetic coding is performed on the pixel by using a difference D between an actual value X and the predictor P of the to-be-encoded pixel. For ease of description, the difference used for the subsequent arithmetic coding is referred to as first intermediate data.

There may be several methods for determining the predictor P, and this is not limited in this embodiment of this application. For example, for the predictor P of an element in each sub-block, a value of the predictor P may be a value of a first element in a same row as the element, or a value of a first element in a same column as the element.

Because a size of each block is small enough, even if the intra-frame prediction is performed based on the first image data corresponding to a pixel in another block, restoration does not cause a comparatively great impact on efficiency. Therefore, in this embodiment, different blocks, first image data corresponding to pixels in different sub-blocks may be used as a basis for the intra-frame prediction, to achieve an objective of maximally eliminating redundancy, thereby improving an image compression rate.

S550. Perform arithmetic coding in parallel on first intermediate data included in the different sub-blocks obtained by dividing each block.

The arithmetic coding is described by using occurrence probabilities of various types of to-be-encoded data as a first parameter and coding intervals of the data as a second parameter. The arithmetic coding may be classified into two types, namely, static arithmetic coding and adaptive arithmetic coding. In the static arithmetic coding, the occurrence probabilities of the various types of data are fixed. However, in the adaptive arithmetic coding, probabilities of the various types of data are not fixed, but are dynamically modified based on an occurrence frequency of the various types of data during the coding. Specifically, before the adaptive arithmetic coding, it is first assumed that the occurrence probabilities of all types of data are equal. After a piece of data is received and the arithmetic coding is performed on the data, the occurrence probability of the data is updated.

The following describes some technical solutions provided in this application in an adaptive arithmetic coding manner. When the size of the block is eight rows and eight columns, each block includes data corresponding to 64 pixels, and data corresponding to each pixel includes location information of the pixel in the block and a predictor of the pixel. When an 8-bit binary value is used to represent the predictor of the pixel (in other words, a range of the predictor is 0 to 255), a probability model corresponding to each block needs to include 64×256 probabilities. A possible value of the predictor of each pixel corresponds to one probability. For example, the 64 pixels included in the block are numbered from 0 to 63. When the arithmetic coding is performed on a pixel whose number is 20, a predictor and a difference (namely, the first intermediate data) of the pixel whose number is 20 are first determined, a corresponding probability is found from the probability model based on the predictor and the number of the pixel, and the coding is performed on the difference of the pixel based on the probability.

When the adaptive arithmetic coding is used, an initial value of each probability in the probability model is 0.5, it indicates that a probability that a value of each bit of an actual value corresponding to each pixel is 0 or 1 is 0.5. When the arithmetic coding is performed on a first sub-block of a first block, the arithmetic coding is performed based on the current probability model, and the used probability is adaptively modified, to update the probability model. When the coding is performed on a first sub-block in a second block, a probability model updated when the arithmetic coding is performed on the first sub-block in the first block may be used, and so on. In other words, associated sub-blocks may sequentially use and update a probability model, and the probability model matches a size of the sub-block. In this way, when the arithmetic coding is sequentially performed in parallel on the first intermediate data included in the different sub-blocks obtained by dividing each block, only a probability model including 64×256 probabilities, namely, a size of an arithmetic model corresponding to one block needs to be stored at a same moment, and the probability model is updated with the arithmetic coding.

S560. Encapsulate data obtained after the arithmetic coding.

Based on data obtained after the arithmetic coding is performed on each sub-block and the JPEG header field data obtained through parsing in the step S510, the data obtained after the arithmetic coding and the JPEG header field data are encapsulated to obtain second image data.

FIG. 11 is a schematic diagram of an encapsulation format of second image data according to an embodiment of this application. As shown in FIG. 11, the encapsulation format of the second image data includes the following three parts.

A sub-block information part, the part is used to record a quantity of sub-blocks obtained by dividing an entire image and a length of each sub-block. During decoding, an image processing engine may place data of a same sub-block into a same decoding module based on the sub-block information part, to implement parallel decoding.

A compressed JPEG header data part, the part is obtained by compressing raw JPEG header data. After JPEG image data is compressed, compressed image needs to be losslessly decompressed back to the raw JPEG image data. Because another part of the JPEG image data except the header field data has been compressed based on the foregoing solution, lossless compression needs to be separately performed on the JPEG header field data part. In this way, the JPEG header field data part after the lossless compression is performed is used as a part of the encapsulation format of the compressed second image data. A compression algorithm for compressing the JPEG header field data herein may be any one of general compression algorithms, for example, a differential coding algorithm, a Huffman coding algorithm, or an Lempel-Ziv-Welch (LZW) compression algorithm. This is not limited in this application. Optionally, if image data of another format is processed in this embodiment, the compressed JPEG header field data part herein is changed into a header field data part of a corresponding format.

A compressed sub-block part is used to store data of a sub-block obtained after intra-frame prediction and arithmetic coding. Because the quantity of the sub-blocks and a data volume corresponding to each sub-block are already recorded in the sub-block information part, data of each sub-block may be arranged closely in the compressed sub-block part. No other data needs to be inserted between the sub-blocks as an interval, to improve packet efficiency.

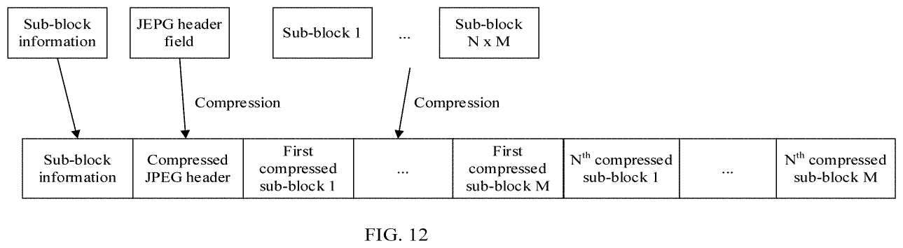

The second image data generated in this embodiment may alternatively be of another encapsulation format. FIG. 12 is a schematic diagram of another encapsulation format of second image data according to an embodiment of this application. As shown in FIG. 12, a sequence of sub-blocks in a compressed sub-block part changes. In this embodiment of this application, a unified method is used for block division. Therefore, data included in sub-blocks obtained by dividing a same block may be placed together, and an arrangement sequence of the sub-blocks in each block keeps consistent. For example, in the example in FIG. 8, each block is divided into four sub-blocks, and the four sub-blocks are numbered in a sequence from a sub-block 1 to a sub-block 4. In the encapsulation method, the four sub-blocks obtained by dividing the same block are placed together and arranged in a specific sequence, for example, in a sequence of a sub-block 2, a sub-block 3, the sub-block 1, and the sub-block 4. Sub-blocks of another block also need to be arranged according to the sequence. In this method, decoding can be performed as long as a quantity of sub-blocks obtained by dividing each block, a length of each sub-block, and a location of each sub-block in a block are recorded in a sub-block information part, to further improve packet encapsulation efficiency.

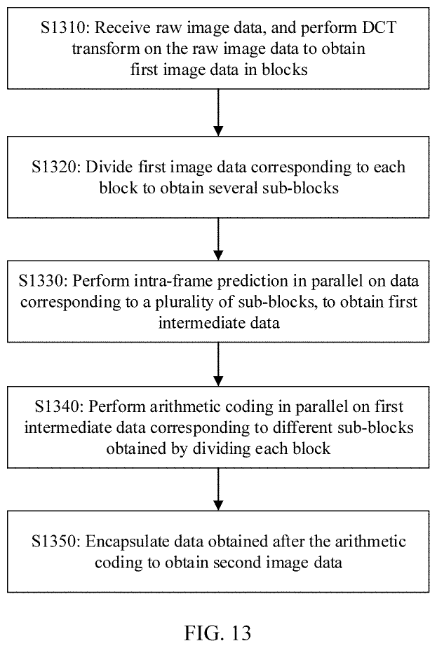

FIG. 13 is a schematic flowchart of another embodiment of this application.

In the embodiment shown in FIG. 5, from the JPEG image data, operations such as the Huffman decoding are performed on the JPEG image data to obtain data obtained after the DCT is performed on the raw image data. In the embodiment shown in FIG. 13, compression processing is performed from raw image data. The embodiment shown in FIG. 13 includes the following steps.

S1310. Receive the raw image data, and perform DCT on the raw image data to obtain first image data on a block-basis.

The raw image data indicates data that is directly obtained by an apparatus such as a camera, a sensor, or a camera and that is not processed. The raw image data is usually obtained by describing each pixel in an image by using a color model. For example, each pixel in the image is described by using a scheme such as an RGB scheme, or a YCbCr scheme. Different from JPEG image data, the raw image data does not include a header field. Therefore, the raw image data does not need to be parsed.

Because the DCT is performed on the raw image data in coding units, the data on a block basis may be obtained after the DCT. A size of a block is the same as a size of a coding unit.

S1320. Divide data included in each block to obtain several sub-blocks.

S1330. Perform intra-frame prediction in parallel on data corresponding to a plurality of sub-blocks, to obtain first intermediate data.

S1340. Perform arithmetic coding in parallel on first intermediate data corresponding to different sub-blocks obtained by dividing each block.

S1350. Encapsulate data obtained after the arithmetic coding to obtain second image data.

Because the raw image data does not have header field data, the image data obtained after the encapsulation includes two parts, which are specifically as follows a sub-block information part, used record a quantity of sub-blocks obtained by dividing an entire frame of image and a length of each sub-block, and a compressed sub-block part, used to store a compressed sub-block.

Similar to the step S560, the image data generated through the data encapsulation in this embodiment may also be of another format. This is not limited in this application.

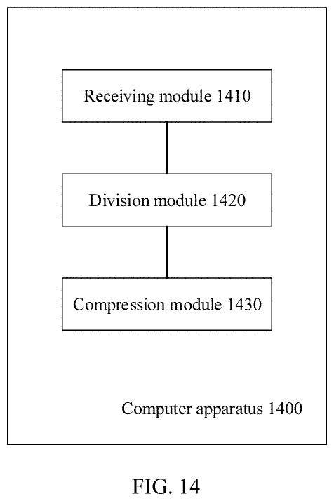

FIG. 14 is a schematic diagram of modules of a computer apparatus 1400 according to an embodiment of this application. As shown in FIG. 14, the computer apparatus 1400 includes a receiving module 1410, configured to obtain N blocks in first image data, where the first image data is intermediate data obtained after a DCT is performed on raw image data, a size of each of the N blocks is equal to a size of a coding unit, the coding unit is a data unit used in a process of performing a DCT on the raw image data, and N is a positive integer, a division module 1420, configured to divide each of the N blocks into M sub-blocks, to obtain N×M sub-blocks, where M is a positive integer, and a compression module 1430, configured to separately compress each of the N×M sub-blocks, and encapsulate compressed data, to obtain second image data.

The computer apparatus is further configured to perform image data compression operations shown in FIG. 5 and FIG. 13. Specifically, the receiving module 1410 is configured to perform the steps such as S510, S520, and S1310, the division module 1420 is configured to perform the steps such as S530 and S1320, and the compression module 1430 is configured to perform the steps such as S540 to S560, and S1330 to S1350. Details are not described herein again.

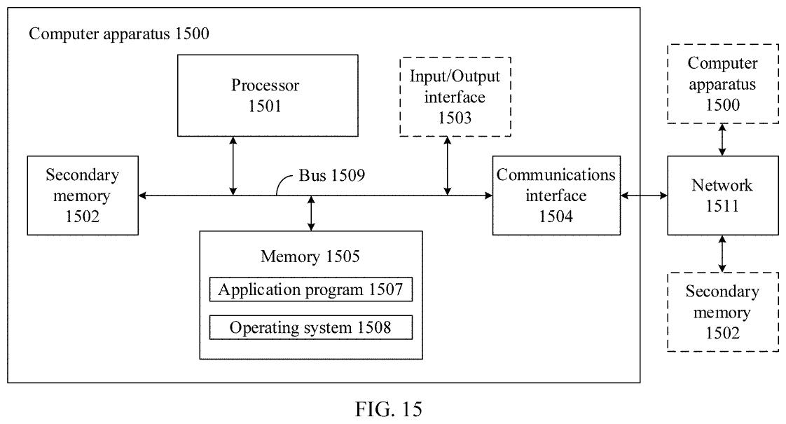

FIG. 15 is a schematic diagram of a structure of a computer apparatus 1500 according to an embodiment of this application.

As shown in FIG. 15, the computer apparatus 1500 includes a processor 1501. The processor 1501 is connected to a system memory 1505. The processor 1501 may be computing logic such as, a CPU, a GPU, an FPGA, a DSP, or a combination of any of the foregoing computing logics. The processor 1501 may be a single-core processor or a multi-core processor.

A bus 1509 is configured to transmit information between components of the computer apparatus 1500. The bus 1509 may use a wired connection manner or a wireless connection manner. This is not limited in this application. The bus 1509 is further connected to a secondary memory 1502, an input/output interface 1503, and a communications interface 1504.

The secondary memory 1502 is usually also referred to as an external memory. A storage medium of the secondary memory 1502 may be a magnetic medium (for example, a floppy disk, a hard disk, or a magnetic tape), an optical medium (for example, an optical disc), a semiconductor medium (for example, a solid-state drive (SSD)), or the like. In some embodiments, the secondary memory 1502 may further include a remote memory separated from the processor 801, for example, a web disk (including a network or cluster file system such as a network file system (NFS)) accessed by using the communications interface 1504 and a network 1511.

The input/output interface 1503 is connected to an input/output device, and is configured to receive input information, and output an operation result. The input/output device may be a mouse, a keyboard, a display, a compact disc-read-only memory (CD-ROM) drive, or the like.

The communications interface 1504 uses, for example, but is not limited to, a transceiver apparatus such as a transceiver, to implement communication with another device or the network 1511. The communications interface 1504 may be interconnected to the network 1511 in a wired or wireless manner.

In this embodiment of this application, some features may be implemented/supported by the processor 1501 by executing software code in the system memory 1505. The system memory 1505 may include some software, for example, an operating system 1508 (such as Darwin, RTX, LINUX, UNIX, OS X, WINDOWS, or an embedded operating system (such as VXWORKS)), an application program 1507, or the like.

In addition, FIG. 15 shows an example of the computer apparatus 1500. The computer apparatus 1500 may include more or fewer components than those shown in FIG. 15, or may have different component arrangements. For example, in a possible implementation, the processor 1501 of the computer apparatus 1500 provided in this application is an FPGA, and the computer apparatus 1500 does not include the independent system memory 1505, but stores software code in the processor 1501. In this case, some features in this embodiment of this application may be implemented/supported by the processor 1501 by executing the software code stored in the processor 1501.

In addition, each component shown in FIG. 15 may be implemented by hardware, software, or a combination of hardware and software. This is not limited in this application.

An embodiment of the present disclosure further provides a computer non-transient storage medium. The computer non-transient storage medium stores an instruction. When the instruction is run on a processor, the method procedure shown in FIG. 5 or FIG. 13 is implemented.

An embodiment of the present disclosure further provides a computer program product. When the computer program product runs on a processor, the method procedure shown in FIG. 5 or FIG. 13 is implemented.

1. An image compression method, implemented by a computer apparatus, the image compression method comprising:
performing a discrete cosine transform (DCT) on each of a plurality of coding units of raw image data to obtain first intermediate data;
obtaining N blocks from the first intermediate data, wherein the coding units and each of the N blocks have a same size;
dividing each of the N blocks into M sub-blocks;
separately compressing each of the sub-blocks to obtain first compressed data; and
encapsulating the first compressed data to obtain image data.

2. The image compression method of claim 1, further comprising dividing each of the N blocks into M sub-blocks using a same division method, wherein a location of an i^{th} sub-block in each block is the same, and 1≤i≤M.

3. The image compression method of claim 1, further comprising dividing a first block of the N blocks based on energy distribution of the first block, wherein the energy distribution reflects distribution of values of data comprised in the first block.

4. The image compression method of claim 1, wherein compressing further comprises:
performing intra-frame prediction on data in each of the sub-blocks to obtain second intermediate data corresponding to each of the sub-blocks; and
separately performing arithmetic coding on the second intermediate data to obtain the first compressed data corresponding to each of the sub-blocks.

5. The image compression method of claim 4, further comprising:
obtaining a plurality of probability models;
performing arithmetic coding on a first block of the N blocks using the probability models to obtain second compressed data corresponding to the first block, wherein each of the sub-blocks corresponds to one of the probability models; and
performing arithmetic coding on a second block of the N blocks using the probability models to obtain third compressed data corresponding to the second block.

6. The image compression method of claim 5, further comprising performing intra-frame prediction on the second intermediate data to obtain third intermediate data corresponding to a sub-block in the second block.

7. The image compression method of claim 1, wherein the image data comprises a header field part and a data part, wherein the header field part indicates a data volume of second compressed data corresponding to each of the sub-blocks, and wherein the data part carries the second compressed data.

8. The image compression method of claim 1, further comprising:
converting the raw image data into joint photographic experts group (JPEG) image data to quantize the JPEG image data; and
scaling up the JPEG image data according to a specific proportion.

9. An image compression apparatus, comprising:
a processor;
a memory coupled to the processor and configured to store instructions that, when executed by the processor, cause the image compression apparatus to be configured to:
perform a discrete cosine transform (DCT) on each of a plurality of coding units of raw image data to obtain first intermediate data;
obtain N blocks from the first intermediate data, wherein the coding units and each of the N blocks have a same size;
divide each of the N blocks into M sub-blocks;
separately compress each of the sub-blocks to obtain first compressed data; and
encapsulate the first compressed data to obtain image data.

10. The image compression apparatus of claim 9, wherein the instructions further cause the image compression apparatus to be configured to divide each of the N blocks into M sub-blocks using a same division method, wherein a location of an i^{th} sub-block in each block is the same, and 1≤i≤M.

11. The image compression apparatus of claim 9, wherein instructions further cause the image compression apparatus to be configured to divide a first block of the N blocks based on energy distribution of the first block, wherein the energy distribution reflects distribution of values of data comprised in the first block.

12. The image compression apparatus of claim 9, wherein the instructions further cause the image compression apparatus to be configured to:
perform intra-frame prediction on data in each of the sub-blocks to obtain second intermediate data corresponding to each of the sub-blocks; and
separately perform arithmetic coding on the second intermediate data to obtain the first compressed data corresponding to each of the sub-blocks.

13. The image compression apparatus of claim 12, wherein instructions further cause the image compression apparatus to be configured to:
obtain a plurality of probability models;
perform arithmetic coding on a first block of the N blocks using the probability models to obtain second compressed data corresponding to the first block, wherein each of the sub-blocks corresponds to one of the probability models; and
perform arithmetic coding on a second block of the N blocks using the probability models to obtain third compressed data corresponding to the second block.

14. The image compression apparatus of claim 13, wherein the instructions further cause the image compression apparatus to be configured to perform intra-frame prediction on the second intermediate data to obtain third intermediate data corresponding to a sub-block in the second block.

15. The image compression apparatus of claim 9, wherein the image data comprises a header field part and a data part, wherein the header field part indicates a data volume of second compressed data corresponding to each of the sub-blocks, and wherein the data part carries the second compressed data.

16. The image compression apparatus of claim 9, wherein instructions further cause the image compression apparatus to be configured to:
convert the raw image data into joint photographic experts group (JPEG) image data to quantize the JPEG image data; and
scale up the JPEG image data according to a specific proportion.

17. A computer program product comprising computer-executable instructions stored on a non-transitory computer-readable medium that, when executed by a processor, cause an image compression apparatus to:
perform a discrete cosine transform (DCT) on each of a plurality of coding units of raw image data to obtain first intermediate data;
obtain N blocks from the first intermediate data, wherein the coding units and each of the N blocks have a same size;
divide each of the N blocks into M sub-blocks;
separately compress each of the sub-blocks to obtain first compressed data; and
encapsulate the first compressed data to obtain image data.

18. The computer program product of claim 17, wherein the instructions further cause the image compression apparatus to divide each of the N blocks into M sub-blocks using a same division method, wherein a location of an i^{th} sub-block in each block is the same, and 1≤i≤M.

19. The computer program product of claim 17, wherein the instructions further cause the image compression apparatus to divide a first block of the N blocks based on energy distribution of the first block, wherein the energy distribution reflects distribution of values of data comprised in the first block.

20. The computer program product of claim 17, wherein the instructions further cause the image compression apparatus to:
perform intra-frame prediction on data in each of the sub-blocks to obtain second intermediate data corresponding to each of the sub-blocks; and
separately perform arithmetic coding on the second intermediate data to obtain the first compressed data corresponding to each of the sub-blocks.
